(19) United States
(12) Patent Application Publication
(10) Pub. No.: US 2026/0356521 A1
(43) Pub. Date: Nov. 12, 2026

(54) LAUNCHING CONTAINER ASSEMBLY FOR MOBILE PLATFORMS

(71) Applicant: Perennial Autonomy, LLC, Menlo Park, CA (US)

(72) Inventors: Robert Donald VOCKE, III, San Jose, CA (US); Christian Johan Owen HANDLEY, San Francisco, CA (US); Shawna MOORE, Mountain View, CA (US); David SCHNELLE, Palo Alto, CA (US); Arya AZIZI, Los Gatos, CA (US); Michael Shane WILKERSON, Summerville, SC (US)

(21) Appl. No.: 19/672,511

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. B64U 80/70; B64U 80/40; B65D 88/12; B65D 90/00; B65D 90/66

(52) U.S. Cl. CPC B64U 80/70; B64U 80/40; B65D 88/121; B65D 90/004; B65D 90/008; B65D 90/66; B65D 2588/74; B65D 2590/66

(57) ABSTRACT

A launching container assembly includes an International Organization for Standardization (ISO) shipping container that includes a body that extends a length from a first end to a second end. The body includes an interior compartment configured to hold a stack of mobile platforms therein, a bottom wall extending along the length of the body, side walls extending from the first end to the second end, end walls at the first and second ends, and a top extending along the length of the body. The top includes a closed position and an open position. The body includes an exit opening in the open position of the top. The top is configured to move from the closed position to the open position such that the mobile platforms are configured to be launched from the interior compartment of the ISO shipping container through the exit opening.

### CROSS-REFERENCE TO RELATED APPLICATIONS

This non-provisional utility application claims priority to provisional patent application number 63/815,810, entitled “LAUNCHING CONTAINER ASSEMBLY FOR MOBILE PLATFORMS” and filed on Jun. 1, 2025, provisional patent application number 63/807,413, entitled “LAUNCHING CONTAINER USING SUPPORTS FOR MOBILE PLATFORMS” and filed on May 16, 2025, provisional patent application number 63/803,081, entitled “MOBILE PLATFORM DEPLOYMENT METHOD AND SYSTEM” and filed on May 9, 2025, provisional patent application number 63/854,392, entitled “DUAL-PURPOSE BOOT AND METHOD OF MANUFACTURE” and filed on Jul. 30, 2025, provisional patent application number 63/960,687, entitled “CONTAINER ASSEMBLY WITH SECURING MECHANISM” and filed on Jan. 14, 2026, provisional patent application number 63/910,760, entitled “MOBILE PLATFORM STACKING ASSEMBLY” and filed on Nov. 3, 2025, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Existing methods and systems for deploying mobile platforms (e.g., rotor craft, fixed-wing, other uncrewed and/or autonomous aircraft, etc.) exhibit a variety of technical disadvantages.

### SUMMARY

In an aspect, a launching container assembly includes an International Organization for Standardization (ISO) shipping container that includes a body that extends a length from a first end to a second end. The body includes an interior compartment configured to hold a stack of mobile platforms therein, a bottom wall extending along the length of the body, side walls extending from the first end to the second end, end walls at the first and second ends, and a top extending along the length of the body. The top includes a closed position and an open position. The body includes an exit opening in the open position of the top. The top is configured to move from the closed position to the open position such that the mobile platforms are configured to be launched from the interior compartment of the ISO shipping container through the exit opening.

In another aspect, a launching container assembly includes a stack of mobile platforms, and an ISO shipping container that includes a body that extends a length from a first end to a second end. The body includes an interior compartment holding the stack of mobile platforms therein, a bottom wall extending along the length of the body, side walls extending from the first end to the second end, end walls at the first and second ends, and a top extending along the length of the body and including a closed position and an open position. The body includes an exit opening in the open position of the top. The top is configured to move from the closed position to the open position such that the mobile platforms are configured to be launched from the interior compartment of the ISO shipping container through the exit opening.

In another aspect, a method includes moving a top of an ISO shipping container from a closed position of the top to an open position of the top such that the ISO shipping container includes an exit opening, wherein the ISO shipping container contains a stack of mobile platforms in an interior compartment of the ISO shipping container. The method includes launching the mobile platforms from the interior compartment of the ISO shipping container through the exit opening of the ISO shipping container.

### BRIEF DESCRIPTION OF THE DRAWINGS

FIG. 1 is an isometric view illustrating a launching container assembly according to an implementation.

FIG. 2 includes elevational and side views of launching container assemblies according to an implementation.

FIG. 3 is an elevational schematic view of the launching container assembly shown in FIG. 1 according to an implementation.

FIG. 4 is a plan schematic view of the launching container assembly shown in FIG. 1 according to an implementation.

FIG. 5 is an elevational schematic view illustrating a launching container assembly according to an implementation.

FIG. 6 is an elevational schematic view of the launching container assembly shown in FIG. 5 according to an implementation.

FIG. 7 is an elevational schematic view illustrating a launching container assembly according to an implementation.

FIG. 8 is an isometric view of guide elements according to an implementation.

FIG. 9 is an elevational schematic view illustrating a launching container assembly according to an implementation.

FIG. 10 is a flowchart illustrating a method of operation of a launching container assembly according to an implementation.

FIG. 11 is a schematic diagram illustrating an exemplary operating environment of the disclosure according to an implementation.

### DETAILED DESCRIPTION

Existing methods and systems for deploying mobile platforms (e.g., rotor craft, fixed-wing, other uncrewed and/or autonomous aircraft, etc.) exhibit a variety of technical disadvantages. For example, deployment of mobile platforms may present various challenges associated with scalability, speed of deployment, adaptability (e.g., across different environmental conditions and/or operational parameters, etc.), and compatibility with existing infrastructure. In one example, known mobile platform deployment systems rely on fixed bases or portable single-unit launch systems, which lack scalability and have limited deployment speed.

In contrast, aspects of the disclosure integrate mobile platform launch systems into shipping containers, such as standard International Organization for Standardization (ISO) shipping containers, for example providing more rapid, large-scale deployment of mobile platforms. The integration of mobile platform launch systems into shipping containers addresses challenges faced by existing systems by, for example, utilizing available logistics networks and infrastructure. Aspects of the disclosure provide a technical solution that offers enhanced transportation, improved integration with current logistical chains, and improved deployment capabilities, for example in diverse environments. Aspects of the disclosure pertain to a containerized system designed to deploy a greater number of mobile platforms more rapidly, leveraging shipping containers as mobile launch platforms. The integration of mobile platform launch systems into shipping containers (e.g., ISO shipping containers available in 20-foot and 40-foot sizes, etc.) as disclosed herein facilitates compatibility with existing transportation and logistical systems.

In some examples, aspects of the disclosure encompass a launch rail mechanism for the staged release of mobile platforms, for example employing approximately vertical guide rods and/or tubes for rotorcraft and oblique angled pneumatic launchers for fixed-wing aircraft. A top (e.g., roof, etc.) of the shipping container is configured to open, for example to enable faster deployment of a group of mobile platforms. The top of the shipping container may be configured to open in any configuration, such as, but not limited to, panel doors (e.g., similar to a conventional garage door, single panel doors, sectional panel doors that fold, etc.) that move along rails to slide open, roller doors that roll-up, hinged designs, clamshell designs, and/or the like.

In some examples, the shipping container includes a modular design that incorporates palletized racks for mobile platforms, for example enabling more efficient loading and/or unloading, adaptability to customizable operation profiles, and/or the like. Aspects of the disclosure support remote and automated operation, for example enabling for computer-initiated launch sequences. Aspects of the disclosure provide the shipping container as a remote launch base station with diverse power management options, for example including generators, solar panels, batteries, and/or the like. In some examples, aspects of the disclosure provide environmental resilience, for example including heating and/or other mechanisms for snow and/or ice prevention that facilitate operability in adverse weather conditions. Aspects of the disclosure provide a more versatile, scalable, and efficient solution for mobile platform deployment.

In some examples, the use of a standard ISO shipping container as the basis of a launch container enables any ISO standard processing and logistics infrastructure to store, handle, transport, and support the launching container assemblies disclosed herein. In some examples, launch container assemblies disclosed herein makes use of the extensive and cost effective global civilian supply chains for both containers and any handling or transportation equipment.

Examples of applications of the subject matter disclosed herein include, but are not limited to, community monitoring, disaster response and/or recovery, environmental monitoring, commercial applications, military applications, and/or the like.

Examples of community monitoring applications include deploying mobile platforms for tasks such as crowd monitoring, search and rescue operations, area surveillance, and/or the like. The methods and assemblies disclosed herein enhance the ability to manage relatively large-scale events and/or emergency situations by providing more rapid aerial deployment capabilities while minimizing the necessity for extensive on-ground personnel.

Examples of commercial applications include deploying mobile platforms for fleet-based operations in agriculture, infrastructure inspection, logistics delivery services, and/or the like. The methods and assemblies disclosed herein enable companies to position mobile platform deployment stations strategically, for example offering adaptive solutions for reaching remote and/or difficult-to-access locations.

In disaster response scenarios, applications include launching mobile platforms for real-time damage assessment and/or to assist in coordinating rescue efforts. Mobile platforms can be more quickly deployed to survey affected areas, for example providing critical data to first responders and aiding in the efficient allocation of resources.

In some environmental monitoring examples, environmental monitoring agencies may employ the methods and assemblies disclosed herein to more swiftly deploy mobile platforms for data collection and/or monitoring activities, such as wildlife tracking, pollution assessment, and/or the like. The mobility of the shipping container grants unparalleled access to diverse environments, for example enabling vital data to be gathered from multiple sites with fewer logistical constraints.

Aspects of the disclosure operate in an unconventional manner at least by providing a launching container assembly that includes an International Organization for Standardization (ISO) shipping container that includes a body that extends a length from a first end to a second end. The body includes an interior compartment configured to hold a stack of mobile platforms therein, a bottom wall extending along the length of the body, side walls extending from the first end to the second end, end walls at the first and second ends, and a top extending along the length of the body. The top includes a closed position and an open position. The body includes an exit opening in the open position of the top. The top is configured to move from the closed position to the open position such that the mobile platforms are configured to be launched from the interior compartment of the ISO shipping container through the exit opening.

Aspects of the disclosure operate in an unconventional manner at least by providing a launching container assembly that includes a stack of mobile platforms, and an ISO shipping container that includes a body that extends a length from a first end to a second end. The body includes an interior compartment holding the stack of mobile platforms therein, a bottom wall extending along the length of the body, side walls extending from the first end to the second end, end walls at the first and second ends, and a top extending along the length of the body and including a closed position and an open position. The body includes an exit opening in the open position of the top. The top is configured to move from the closed position to the open position such that the mobile platforms are configured to be launched from the interior compartment of the ISO shipping container through the exit opening.

Aspects of the disclosure operate in an unconventional manner at least by providing a method that includes moving a top of an ISO shipping container from a closed position of the top to an open position of the top such that the ISO shipping container includes an exit opening, wherein the ISO shipping container contains a stack of mobile platforms in an interior compartment of the ISO shipping container. The method includes launching the mobile platforms from the interior compartment of the ISO shipping container through the exit opening of the ISO shipping container.

Example technical solutions to the technical problems described herein include the utilization of standard containers (e.g., 20-foot, 40-foot, etc.) as adaptable launch platforms. This technical solution leverages widely available (e.g., existing, etc.) infrastructure and logistics resources to provide the technical effect of enabling scalable, more rapid deployment capabilities, for example utilizing standardized transportation methods for deployment over relatively wide geographic areas. Aspects of the disclosure provide the technical solution of providing the shipping container with an openable roof mechanism, for example using panel doors, rail systems, hinges, hinged segments, foldable segments, clamshell designs, roll-up door styles, explosive panels, and/or the like. For example, the technical solution of an openable top, or roof, of the shipping container (e.g., partial and/or full opening, etc.) provides the technical effect of improving deployment speed and reducing preparation time upon arrival.

Aspects of the disclosure provide the technical solution of a multi-functional launch rail system, for example incorporating launch mechanisms such as approximately vertical guide rods and/or tubes for rotorcraft and pneumatic ejection for fixed-wing aircraft. The technical solution of the launch rail system provides the technical effect of better controlled and more rapid release of various mobile platform types from a single, modular system. Aspects of the disclosure provide the technical solution of an assembly with modular scalability, for example by integrating palletized racks for easy loading and unloading of stacks of mobile platforms. The technical solution of modular scalability provides the technical effects of supporting diverse operation configurations and enabling adaptability and more rapid reconfiguration of mobile platform payloads.

Aspects of the disclosure provide the technical solution of remote and/or automated operation. For example, aspects of the disclosure enable remote opening of the top of the shipping container and/or remote initiation of launch sequences. Moreover, and for example, aspects of the disclosure enable automated opening of the top of the shipping container and/or automated initiation of launch sequences. For example, the remote and/or automated operation provides the technical effects of enhancing operational efficiency, enhancing safety, reducing the necessity for on-site personnel, and/or the like.

Aspects of the disclosure provide the technical solution of environmental adaptation, for example providing the technical effect of facilitating operational reliability under adverse conditions. For example, the methods and assemblies disclosed herein may include reinforcement against environmental influences, such as, but not limited to, including heating elements for snow and/or ice prevention. Incorporation of power management systems is another technical solution of aspects of the disclosure. For example, power sources such as batteries, generators, solar panels, and/or the like provide the technical effects of sustained power supply and operational continuity of launch assemblies and/or mobile platforms during extended use.

Aspects of the disclosure provide the technical effect of enhanced mobility through the utilization of standardized ISO containers, which for example streamline transportation and deployment logistics processes. Technical effects of the disclosure include streamlined scalability and responsiveness in mobile platform operations, for example by utilizing modular system architecture and/or more efficient launch mechanisms. Increased reliability and operational readiness (e.g., through environmental adaptation, more robust power management frameworks, etc.) is another technical effect of the disclosure. Another example of a technical effect of the disclosure includes the reduction of manual labor and potential for human error, for example via remote and/or automated functionalities that, for example, improve safety and operational efficiency.

Examples of mobile platforms (e.g., mobile platforms 104, etc.) include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), aquatic vehicles (e.g., boats, ships, marine vehicles, freshwater vehicles, etc.), surface vehicles, submersibles, uncrewed aquatic vehicles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), missiles, rockets, uncrewed mobile platforms, autonomous mobile platforms, and/or the like. In some examples, a launching container assembly as disclosed herein is used with one or more uncrewed, autonomous platforms.

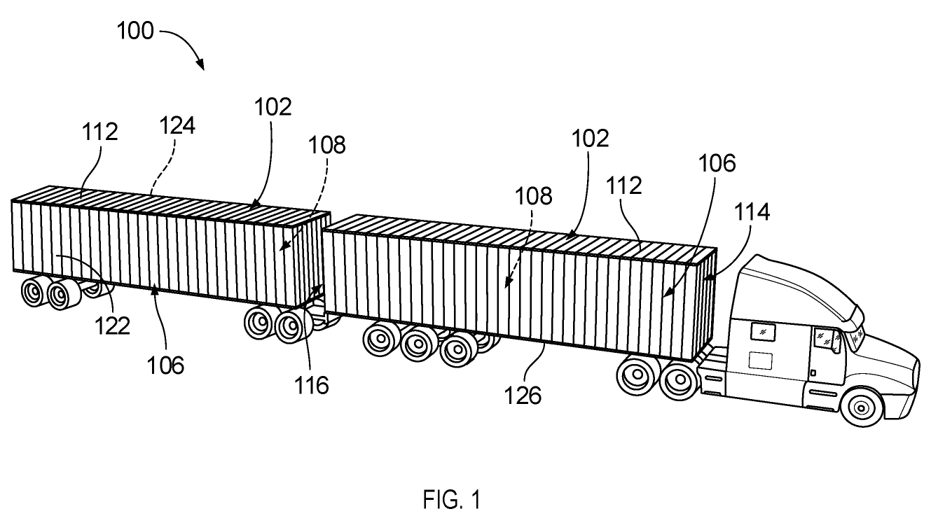

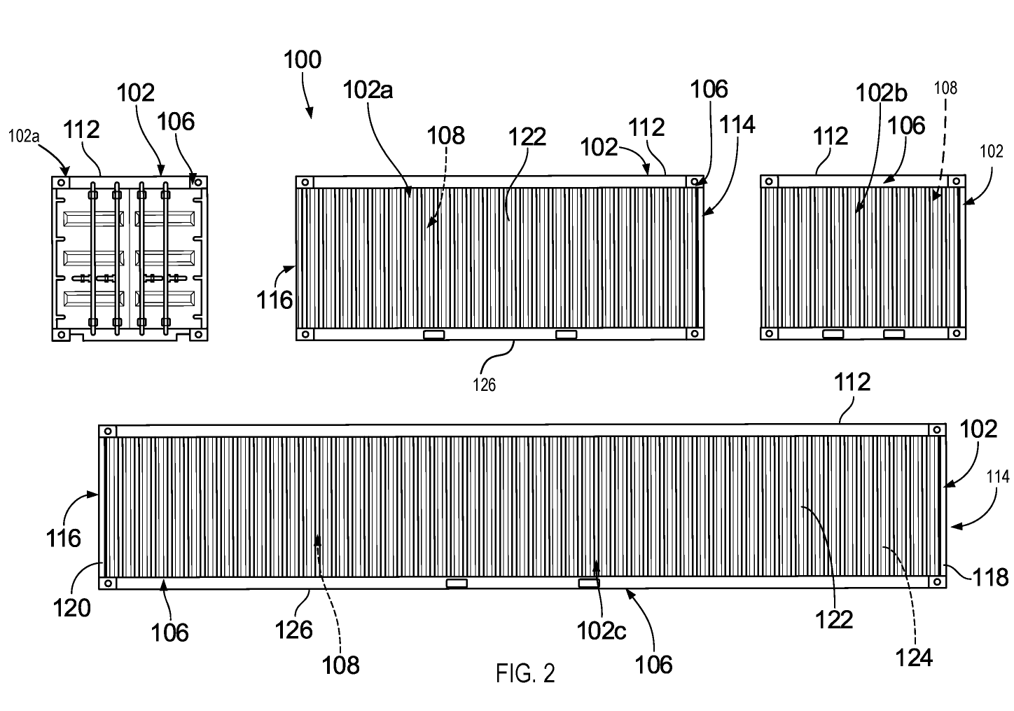

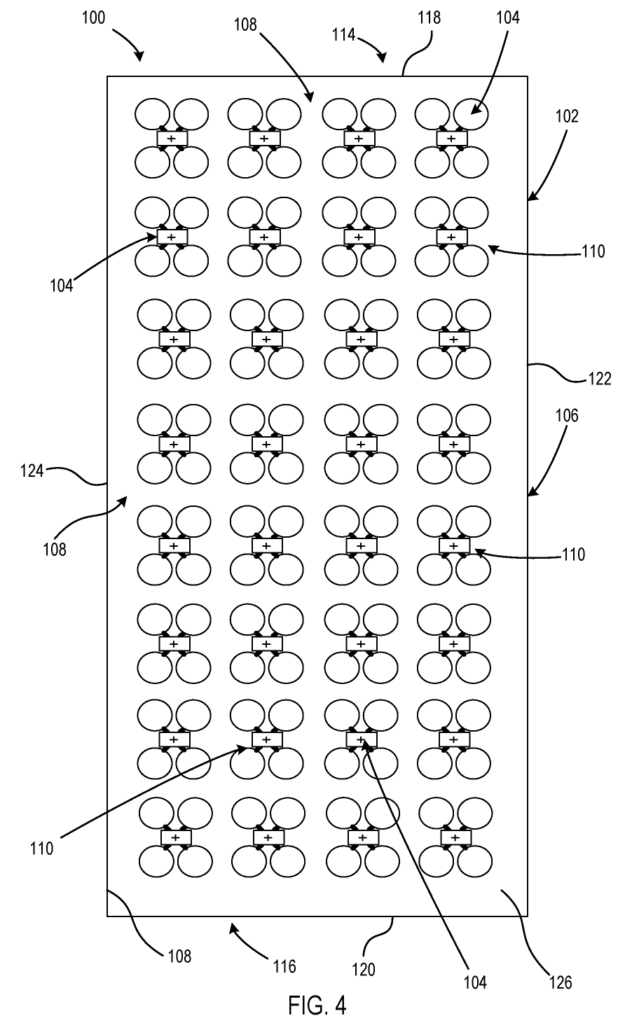

Referring to the figures, FIGS. 1-4 illustrate exemplary implementations of a launching container assembly 100. The launching container assembly 100 includes a shipping container 102 (e.g., an ISO shipping container) and mobile platforms 104 (not visible in FIGS. 1 and 2). The launching container 102 includes a body 106 that includes an interior compartment 108 that is configured to hold one or more stacks 110 (not visible in FIGS. 1 and 2) of the mobile platforms 104 therein. As will be described below, and for example, the body 106 of the shipping container 102 includes a top 112 (not shown in FIG. 4) that opens to enable the mobile platforms 104 to launch directly from the shipping container 102 by exiting the interior compartment 108 through the open top 112. For example, and as will be described below, the top 112 is configured to move from a closed position (e.g., as shown in FIGS. 1-3, etc.) to an open position (e.g., as shown in FIG. 4, etc.) such that the mobile platforms 104 are configured to be launched from the interior compartment 108 through an exit opening 180 (FIG. 4) of the body 106 that is present when the top 112 is in the open position. In the exemplary implementation of FIG. 4, the top 112 has been removed to illustrate the exit opening 180.

In an example in which the shipping container 102 is an ISO shipping container, the shipping container 102 is a standard intermodal container for freight transport that complies with ISO standards (e.g., ISO standard 668:2020, etc.). In some examples, the shipping container 102 is a twenty-foot equivalent (TEU) container, for example a 1 TEU container (approximately 20 feet in length), a 2 TEU container (approximately 40 feet in length, also referred to as a forty-foot equivalent (FEU) container), a 2 TEU container that is approximately 45 feet in length, a 2.4 TEU container, a 2.65 TEU container, a ten-foot length equivalent container, and/or the like. For example, FIG. 1 illustrates two FEU containers 102 being pulled by a semi-trailer truck. In another example, FIG. 2 illustrates side and rear elevational views of a 1 TEU container 102a, a side elevational view of a ten-foot equivalent container 102b, and a side elevational view of a 2 TEU container 102c. In some examples, the ISO shipping container 102 is a High Cube (HC) container (with a standard height of approximately 2.6 meters), a Hi-Cube (HQ) container (with a standard height of approximately 2.9 meters), a half-height container (with a standard height of approximately 1.3 meters, and/or the like. FIG. 2 illustrates HC containers 102a, 102b, and 102c. The shipping container 102 may include any width, such as, but not limited to, approximately 2.4 meters wide, and/or the like.

The body 106 of the shipping container 102 extends a length from an end 114 to an end 116. The body 106 of the shipping container 102 includes end walls 118 and 120 at the ends 114 and 116, respectively. The body 106 includes side walls 122 and 124 that extend lengths from end 114 to the end 116. The body 106 of the shipping container 102 includes the top 112 and a bottom wall 126. The side walls 122 and 124 extend heights from the bottom wall 126 to the top 112. Each of the ends 114 and 116 may be referred to herein as a “first” and/or a “second” end.

As described above, the top 112 of the shipping container 102 is configured to open. For example, at least a portion of the top 112 is configured to move between an open position and a closed position. In the closed position, the top 112 provides a wall of the body 106 that protects the mobile platforms 104 and/or seals the interior compartment 108 during transport, storage, and/or the like. For example, the closed position of the top 112 may provide tip-over protection, camouflage, environmental protection (e.g., from dust, dirt, water, sand, debris, etc.), and/or the like. An exemplary implementation of the open position of the top 112 is shown in FIG. 4, while an exemplary implementation of the closed position of the top 112 is shown in FIGS. 1-3.

The top 112 is configured to retract to expose the interior compartment 108 of the shipping container 102 for launch activities. For example, in the open position, the at least a portion of the top 112 provides the exit opening 180 that opens the interior compartment 108 of the shipping container. The stack(s) 110 of mobile platforms 104 are configured to be launched (e.g., deployed, etc.) directly from the shipping container 102. In other words, each mobile platform 104 is configured to be launched directly from the corresponding stack 110 and directly from the interior compartment 108 of the shipping container 102. The mobile platforms 104 launch directly from the interior compartment 108 of the shipping container 102 by exiting the interior compartment 108 through the exit opening 180 provided by the open position of the top 112. In some examples, one or more mobile platforms 104 launches directly from the interior compartment 108 of the shipping container 102 by moving (e.g., exiting, leaving, flying, etc.), under its own power, through the exit opening 180 provided by the open position of the top 112 of the shipping container 102. For example, in an exemplary implementation wherein the mobile platforms 104 are UAVs, the mobile platforms 104 may launch directly from the shipping container 102 by flying through the open top 112 under their own power. In some examples, direct launch of a mobile platform 104 from the shipping container 102 is assisted by facilitating (e.g., initiating, boosting, replacing, propelling, etc.) the acceleration of the mobile platform 104 off the corresponding stack 110 and through the open top 112, for example by spring loading the mobile platforms 104, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 104 is removed from the corresponding stack 110 before being deployed, for example manually, automatically, autonomously, and/or the like.

In some examples, the mobile platforms 104 are held within the interior compartment 108 of the shipping container 102 for storage and/or transport of the mobile platforms 104. For example, the stack(s) 110 of the mobile platforms 104 may be stored using the shipping container 102 (e.g., within a building or other structure, within a cave and/or other underground area, outside, etc.) for later use. In another example, the launching container assembly 100 is loaded onto another mobile platform (e.g., a vehicle, a semi-trailer, a marine vessel, a train, an aircraft, a mothership, etc.) and transported to another location, for example for deployment of one or more of the mobile platforms 104 from the shipping container 102 at the other location.

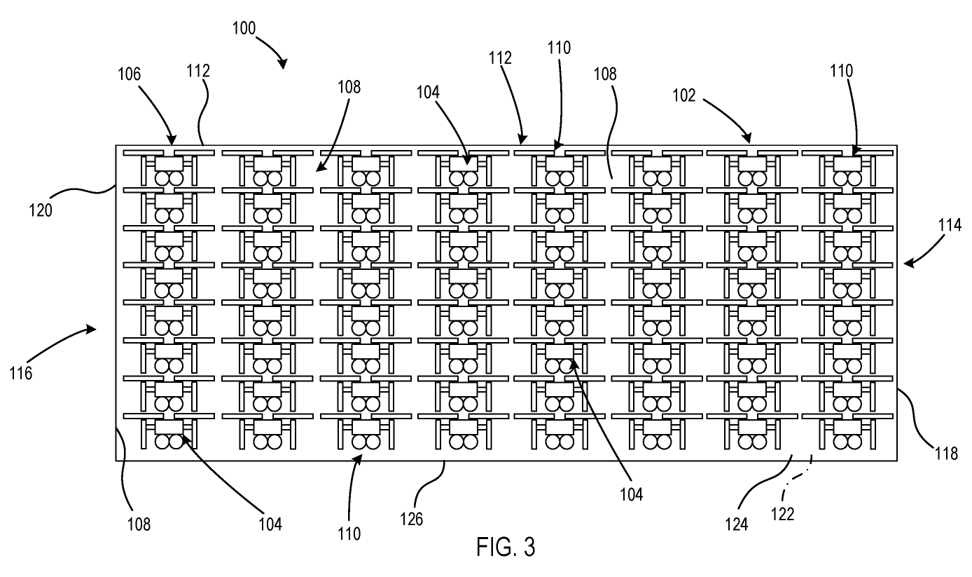

Although eight are shown in FIG. 3, each stack 110 of the mobile platforms 104 may include any number of mobile platforms 104. Moreover, although thirty-two stacks 110 are shown in FIG. 4, the interior compartment 108 of the shipping container 102 may hold any number of stacks 110 of mobile platforms 104. In one example, a 1 TEU container 102 holds thirty-two stacks 110 of eight mobile platforms 104 each, for a total of two-hundred-fifty-six mobile platforms 104. In another example, a 1 TEU container 102 holds thirty-two stacks 110 of nine mobile platforms 104 each, for a total of two-hundred-eighty-eight mobile platforms 104. In another example, a 1 TEU container 102 holds twenty-eight stacks 110 of nine mobile platforms 104 each, for a total of two-hundred-fifty-two mobile platforms 104. In another example, a 1 TEU container 102 holds twenty-eight stacks 110 of eight mobile platforms 104 each, for a total of two-hundred-twenty-four mobile platforms 104.

The pattern of stacks 110 within the interior compartment 108 that is shown herein is exemplary only. The stacks 110 of mobile platforms 104 may additionally or alternatively be arranged in any other pattern (e.g., shape, arrangement, number of rows, number of columns, etc.) within the interior compartment 108. In an exemplary implementation, the stacks 110 are oriented approximately vertical within the interior compartment 108. In other implementations, one or more stacks 110 of mobile platforms 104 extends at an approximate oblique angle within the interior compartment 108. In addition or alternatively to the top 112 being openable, at least a portion of one or more of the end walls 118 and/or 120, the side walls 122 and/or 124, and/or the bottom wall 126 may be configured to open to enable the mobile platforms 104 to launch directly from the interior compartment 108 of the shipping container 102.

In some examples, the launch container assembly 100 includes two or more different types of mobile platforms 104 and/or two or more mobile platforms 104 that perform different functions. For example, the launch container assembly 100 may include one or more rotorcraft and one or more fixed-wing aircraft within the shipping container 102. In an example of different functions, the launch container assembly 100 may include mobile platforms 104 that perform different tasks such as, but not limited to: communication relay; intelligence, surveillance, and reconnaissance (ISR); effector; a special purpose function; and/or the like. In some examples, the mobile platforms 104 are organized, arranged, and/or the like (e.g., in an order, etc.) based on the functionalities performed by the mobile platforms 104. In this way, the mobile platforms 104 can be launched from the shipping container 102 in an order based on the various functions of the mobile platforms 104. For example, the mobile platforms 104 that are desired to be launched first may be organized at the top 112. In one example, mobile platforms 104 with special tasks and/or ISR mobile platforms 104 may be arranged to be the first out of the shipping container 102. Optionally, the mobile platforms 104 are launched from the shipping container 102 in a checkerboard pattern.

Some examples include hierarchical standards for loading, unloading, and/or launching the mobile platforms 104. For example, a group of mobile platforms 104 configured to perform a corresponding operation and/or mission may be packaged onto a corresponding pallet and loaded into the ISO shipping container 102 for deployment of the operation and/or mission from the ISO shipping container 102. In some examples, two or more pallets containing mobile platforms 104 dedicated to one or more different operations and/or missions may be loaded into the ISO shipping container 102, for example to provide the capability of launching two or more missions directly from the ISO shipping container 102. Similarly, two or more ISO containers 102 can be networked together. For example, a container vehicle (e.g., trains, ships, motor vehicles, aircrafts, etc.) may be loaded with two or more of the ISO shipping containers 102 (e.g., as shown in FIG. 1, etc.) to enable the deployment of one or more independent and/or coordinated missions that may be performed by any number of container vehicles deployed by any number, combination, arrangement, and/or the like of the carried ISO shipping containers 102.

The top 112 of the shipping container 102 is moveable between the open position and the closed position using any method, mechanism, structure, means, geometry, type, and/or the like that enables the top 112 to function as described and/or illustrated herein. In some examples, the top 112 of the shipping container 102 includes a door that provides the exit opening 180 through which the mobile platforms 104 exit the interior compartment 108. For example, the top 112 may include a panel door (e.g., a single panel door, a multi-panel sectional door, etc.) that is configured to move to the open position by moving down along the side walls 122 and/or 124 and/or the end walls 118 and/or 120 of the shipping container 102. Some examples of the top 112 include a roller door that is configured to wind up (e.g., around a spool, etc.) to retract to the open position and unwind (e.g., wind out, unspool, etc.) to extend to the closed position. Examples of other types of doors that may be additionally or alternatively included by the top 112 include, but are not limited to, hinged doors, flexible sheets, explosive panels, sectional doors, clamshell arrangements (e.g., twin door panels that are hinged to open away from each other, etc.), and/or the like. In one example of a hinged door, one or more sections of the top 112 are hinged to lift upward. In some examples, providing the top 112 with a clamshell arrangement enables the top 112 to open more fully to increase the size of the exit opening 180 of the top 112 in the open position. The top 112 may include any type of hardware that enables the top 112 to function as described and/or illustrated herein, for example jamb type hardware, track type hardware, tracks, rails, rods, hinges, rollers, springs, torsion springs, extension springs, counterbalances, lift mechanisms, and/or the like.

The configuration of the top 112 to enable the top 112 to move between the open and closed positions may be selected to reduce the time of transitioning from transport to launch mode, for example enhancing operational efficiency. In contrast to existing fixed-roof designs of ISO shipping containers, the openable top 112 facilitates expedited access and deployment, for example reducing deployment preparation time and enhancing operational readiness.

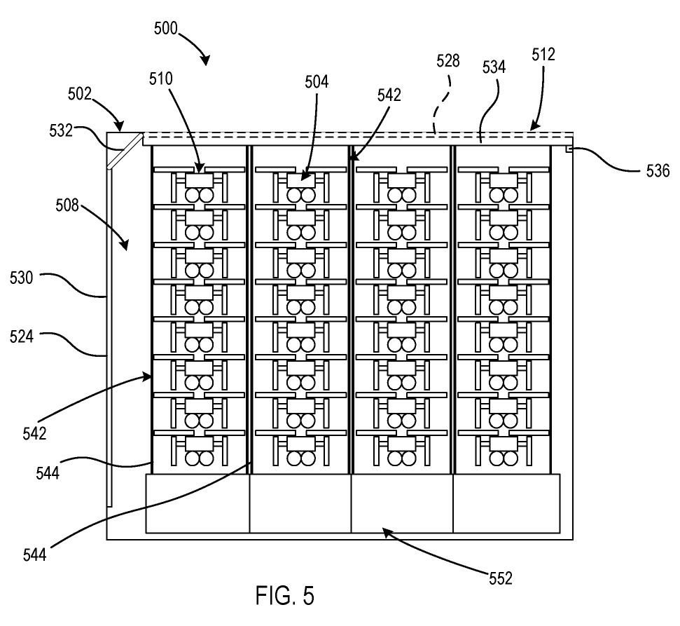

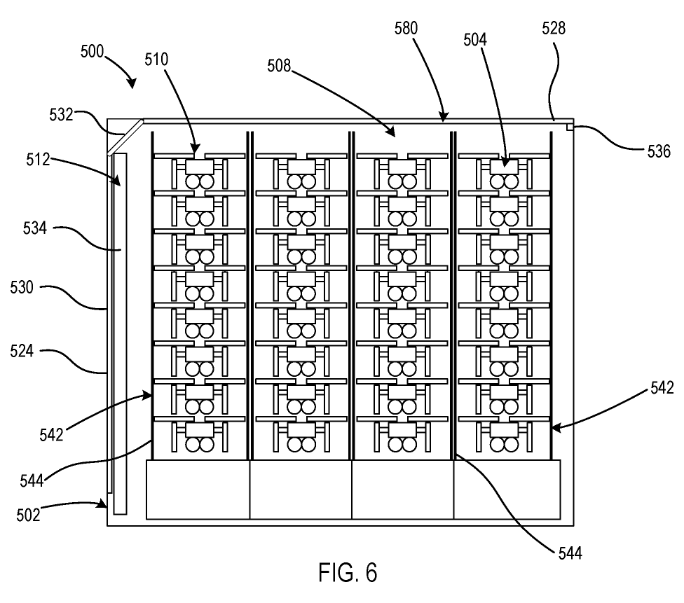

FIGS. 5 and 6 illustrate a launch container assembly 500 having a top 512 with a panel door configuration according to an exemplary implementation. In the example of FIGS. 5 and 6, a shipping container 502 includes a horizontal roof track 528 and a vertical roof track 530 connected together by an oblique and/or curved track segment 532. The top 512 of the shipping container 502 includes a panel door 534 that is held by the tracks 528 and 530 (e.g., using rollers, sliders, etc.) such that the panel door 534 is configured to slide along the tracks 528 and 530. For example, the panel door 534 is configured to slide along the tracks 528 and 530 to move down along a side wall 524 of the shipping container 502 from the closed position shown in FIG. 5 to the open position shown in FIG. 6. In the open position shown in FIG. 6, the open top 512 includes an exit opening 580. Movement of the panel door 534 from the closed position to the open position opens an interior compartment 508 of the shipping container 502 to thereby enable mobile platforms 504 to launch directly from the interior compartment 508 of the shipping container 502 through the exit opening 580 of the top 512. To close the top 512 of the shipping container 502, the panel door 534 is configured to slide along the tracks 528 and 530 to move up along the top 512 of the shipping container 502 from the open position shown in FIG. 6 to the closed position shown in FIG. 5 (i.e., the closed top 512 shown in FIG. 5).

Optionally, the shipping container 502 includes a roof support ledge 536 that facilitates supporting an end of the panel door 534. The shipping container 502 and/or the panel door 534 may include any structure, hardware, mechanism, means, and/or the like that enables the panel door 534 to function as described and/or illustrated herein, such as, but not limited to, tracks, rails, rods, hinges, rollers, springs, torsion springs, extension springs, counterbalances, lift mechanisms, electrical motors, gravity assist devices, and/or the like.

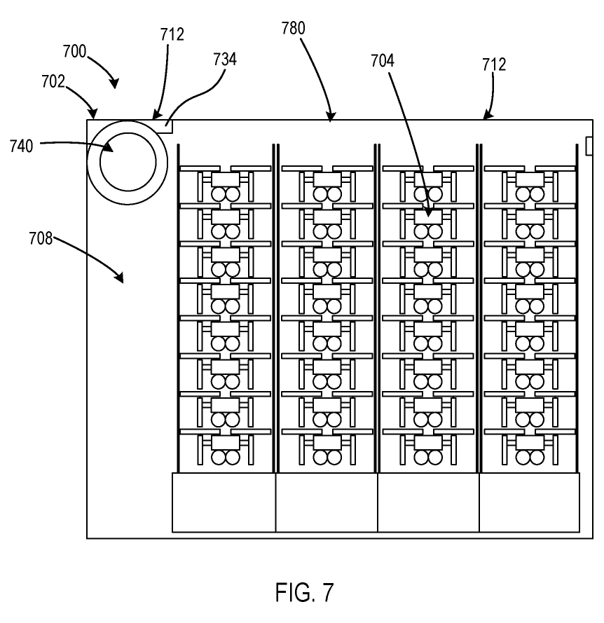

FIG. 7 illustrates a launch container assembly 700 having a top 712 with a roller door configuration according to an exemplary implementation. In the example of FIG. 7, an ISO shipping container 702 includes a spool 740 and the top 712 of the shipping container 702 includes a roller door 734 that is held by the spool 740 such that the roller door 734 is configured to wind around the spool 740. For example, the roller door 734 is configured to wind up around the spool 740 to move (e.g., retract, etc.) from the closed position (not shown) of the top 712 to the open position of the top 712 shown in FIG. 7. In the open position shown in FIG. 7, the open top 712 includes an exit opening 780. Movement of the roller door 734 from the closed position to the open position opens an interior compartment 708 of the ISO shipping container 702 to thereby enable mobile platforms 704 to launch directly from the interior compartment 708 through the exit opening 780. To close the top 712 of the shipping container 702, the roller door 734 is configured to at least partially unwind from the spool 740 to move (e.g., extend, etc.) from the open position of the roller door 734 shown in FIG. 7 to the closed position of the roller door 734.

The shipping container 702 and/or the roller door 734 may include any structure, hardware, mechanism, means, and/or the like that enables the roller door 734 to function as described and/or illustrated herein, such as, but not limited to, tracks, rails, rods, hinges, rollers, springs, torsion springs, extension springs, counterbalances, lift mechanisms, electrical motors, gravity assist devices, and/or the like.

Referring again to FIGS. 3 and 4, the container 102 and/or the stacks 110 of the mobile platforms 104 may include one or more guide elements that are configured to: guide the mobile platforms 104 during launch thereof from the shipping container 102, and/or to hold the mobile platforms 104 in alignment within the corresponding stack 110. The guide elements may include any type, structure, geometry, mechanism, and/or the like, such as, but not limited to, a rail, a rod, a support, a bracket, a tube, a fin, and/or the like. In some examples, the guide element(s) include approximately vertical guide elements. In addition or alternatively, one or more of the guide elements extends approximately horizontally and/or at an oblique angle.

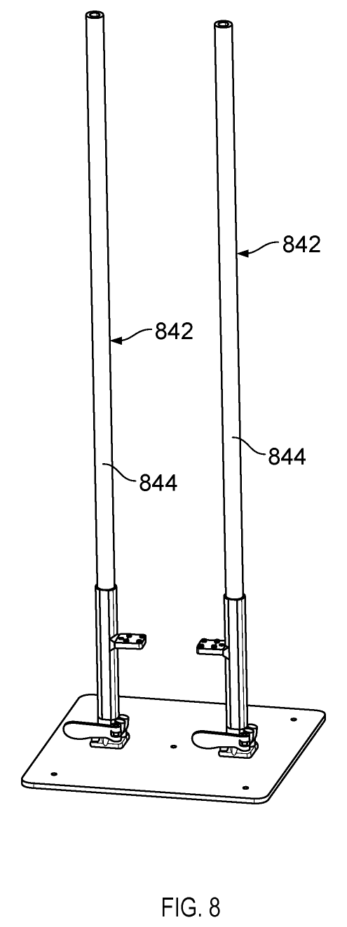

One example of a guide element is shown in FIGS. 5 and 6. For example, the launch container assembly 500 includes guide elements 542 that include tubes 544 that hold (e.g., contain, etc.) corresponding stacks 510 of the mobile platforms 504. FIG. 8 illustrates another example, wherein the guide elements 842 include guide rods 844.

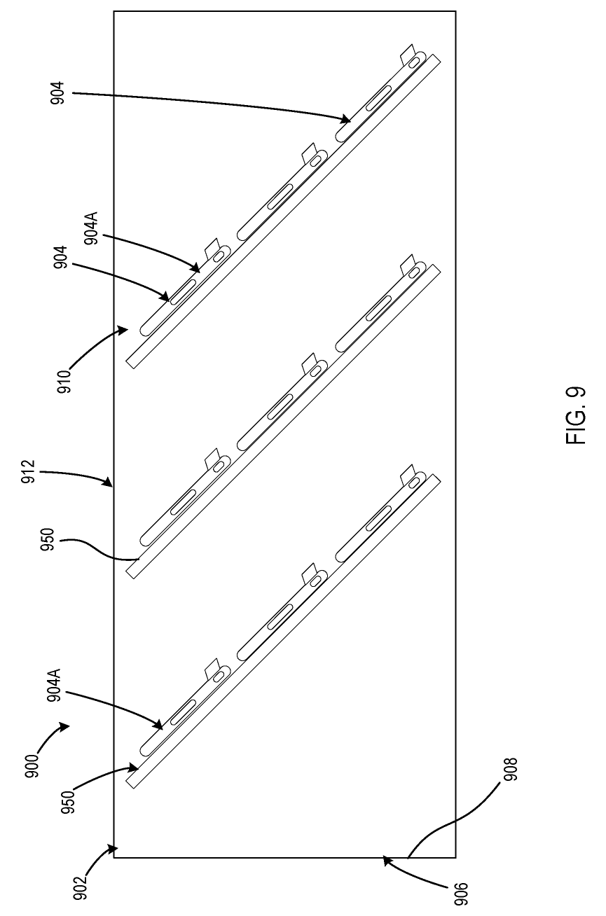

FIG. 9 illustrates a launching container assembly 900 configured for launching mobile platforms 904 that include fixed-wing aircraft 904A. The launching container assembly 900 includes a shipping container 902 and the fixed-wing mobile platforms 904A. The launching container 902 includes a body 906 that includes an interior compartment 908 that is configured to hold one or more magazines 910 of the mobile platforms 904 therein. The body 906 of the shipping container 902 includes a top 912 that opens to enable the mobile platforms 904 to launch directly from the shipping container 902 by exiting the interior compartment 908 through an exit opening of the open top 912. For example, the top 912 is moveable from a closed position (shown in FIG. 9) to an open position (not shown). In the open position, the open top 912 includes the exit opening (not shown).

In some examples, one or more of the fixed-wing mobile platforms 904A launches directly from the interior compartment 908 of the shipping container 902 by flying, under its own power, through the exit opening provided by the open position of the top 912 of the shipping container 902. In addition or alternatively, direct launch of the fixed-wing mobile platforms 904A from the shipping container 902 is assisted by facilitating (e.g., initiating, boosting, replacing, propelling, thrusting, etc.) the acceleration of the fixed-wing mobile platforms 904 out of the interior compartment 908 and through the exit opening of the open top 912. For example, in the exemplary implementation of FIG. 9, the launching container assembly 900 includes pneumatic launch rails 950 that propel the fixed-wing mobile platforms 904A out of the interior compartment 908 through the open top 912. In some examples, the pneumatic launch rails 950 guide the fixed-wing mobile platforms 904A during launch of the mobile platforms 904 from the ISO shipping container 902.

Although illustrated herein with respect to rotorcraft and fixed-wing mobile platforms, as described above the disclosure is not limited thereto. In some examples, the launch container assemblies of the disclosure include ISO shipping containers that are configured to deploy UGVs directly therefrom. In one example, one or more UGVs having a payload of one or more UAVs can be contained within and directly deployed from the ISO shipping container (e.g., at the start of an operation and/or mission; through an open top, side, and/or end of the ISO shipping container; etc.). Aspects of the disclosure utilizing UGVs may provide the technical effect of extending the range of UAVs, for example because UGVs are less weight-limited (as compared to UAVs) and can therefore carry larger and more capable energy systems (e.g., motors, batteries, fuel, solar, etc.).

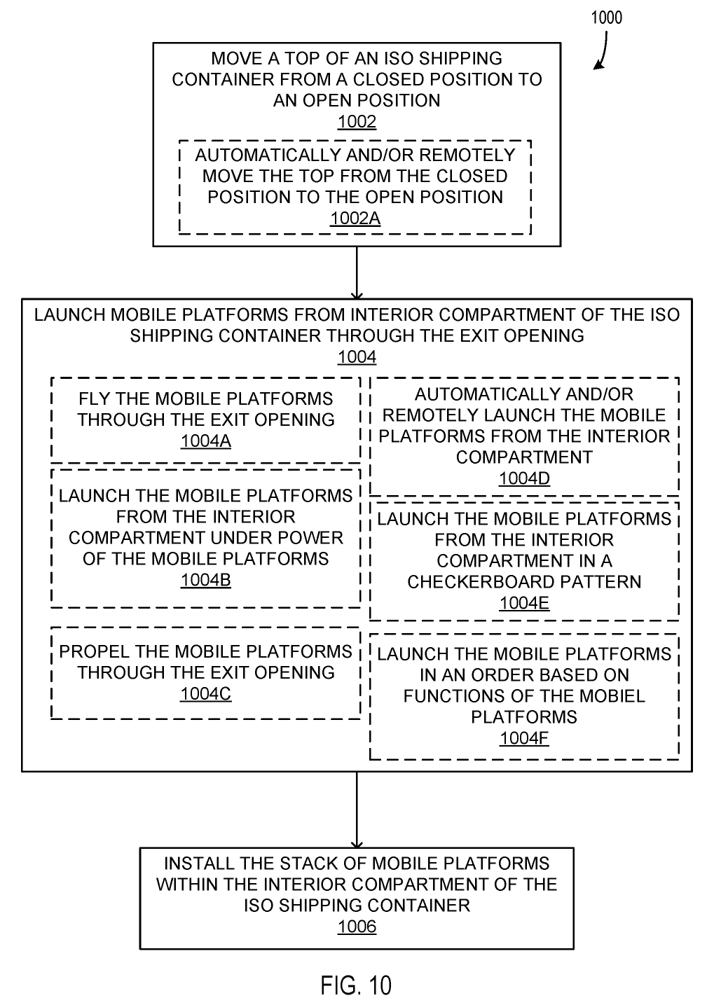

FIG. 10 is a flowchart illustrating an example of a method 1000. At 1002, the method 1000 includes moving a top of an ISO shipping container from a closed position of the top to an open position of the top such that the ISO shipping container includes an exit opening, wherein the ISO shipping container contains a stack of mobile platforms in an interior compartment of the ISO shipping container. At 1004, the method 1000 includes launching the mobile platforms from the interior compartment of the ISO shipping container through the exit opening of the ISO shipping container.

Optionally, moving at 1002 the top of the ISO shipping container from the closed position to the open position includes at least one of automatically or remotely moving, at 1002A, the top from the closed position to the open position.

In some examples, launching at 1004 the mobile platforms from the interior compartment of the ISO shipping container includes at least one of: flying, at 1004A, the mobile platforms through the exit opening of the ISO shipping container; launching, at 1004B, the mobile platforms from the interior compartment under power of the mobile platforms; or propelling, at 1004C, the mobile platforms through the exit opening of the ISO shipping container. Optionally, launching at 1004 the mobile platforms from the interior compartment of the ISO shipping container includes at least one of: at least one of automatically or remotely launching, at 1004D, the mobile platforms from the interior compartment; or launching, at 1004E, the mobile platforms from the interior compartment in a checkerboard pattern.

In some examples, launching at 1004 the mobile platforms from the interior compartment of the ISO shipping container includes launching, at 1004F, the mobile platforms in an order based on functions of the mobile platforms.

Optionally, the method 1000 further includes installing, at 1006, the stack of mobile platforms within the interior compartment of the ISO shipping container.

### Further Implementations

In contrast to existing methods that require manual intervention, the launching container assemblies disclosed herein include, in some examples, remote and/or automated operations. For example, a control system (e.g., a remote control system, an automatic launch system, etc.) could feature automated and/or remote operation capabilities, for example including using computer systems to trigger, initiate, and/or the like mobile platform launch sequences from the ISO shipping container automatically and/or remotely. In another example, a computer system automatically and/or remotely opens the top (e.g., the top 112, etc.) and/or another door of the ISO shipping container (e.g., the ISO shipping container 102, etc.). The automatic and/or remote functionalities reduces the reliance on (e.g., on-site, etc.) personnel, for example enhancing safety.

In some examples, the launch container assembly (e.g., the launch container assembly 100, etc.) includes one or more power sources. For example, aspects of the disclosure provide more robust power management (e.g., through mixed sources such as generators, batteries, solar panels, etc.) enabling more reliable and/or continuous operational capability, a significant enhancement over existing launch systems. Optionally, one or more of the power sources of the launch container assemblies disclosed herein is positioned on the ISO shipping container's exterior. In some examples, the power sources maintain the necessary energy supply for control systems, mobile platform launch, mobile platform operations, and/or the like.

In some examples, a power system of the launch container assemblies disclosed herein is designed with redundant fail-safe mechanisms to ensure operation continuity even if primary systems malfunction. For example, backup launch rails and/or power systems that automatically engage under predefined conditions may be provided, increasing the reliable deployment of all mobile platforms within the ISO shipping container.

Some aspects of the disclosure include a self-diagnostic subsystem that continuously monitors the operational status of the ISO shipping container's launch and power systems. This capability enables early detection of faults or maintenance needs, increasing the chance that the launch system remains in optimal condition, thus reducing downtime and extending operational life.

In some examples, the ISO shipping container (e.g., the shipping container 102, etc.) includes an environmental system (e.g., including a heating mechanism, a cooling mechanism, a defrosting mechanism, and/or the like. The environmental system incorporates features such as space heaters to mitigate snow and/or ice buildup. The environmental system provides more reliable operation in adverse weather conditions. In some examples, the ISO shipping container includes environmental controls, such as space heaters or air conditioners, to manage internal conditions within the interior compartment of the ISO shipping container. The environmental system may enable operation in more extreme temperatures, for example improving the functionality of mobile platform equipment throughout the launch. Optionally, an embedded thermal management system regulates internal temperature, safeguarding mobile platform and electronic system integrity. In some examples, the thermal management system includes active elements (e.g., heat sinks, cooling fans, etc.), for example improving system stability during prolonged operations and/or in higher environmental heat conditions.

Optionally, the interior compartment of the ISO shipping container (e.g., the shipping container 102, etc.) is equipped with a dedicated framework to support mobile platform storage and/or deployment arrangements. For example, the framework may include a series of approximately vertical tubes (e.g., the tubes 544, etc.) for rotorcraft, for example strategically spaced to enable simultaneous and/or sequential launch. In another example of the framework, the ISO shipping container may include a floor grid, a rack, a palletized rack, and/or the like. For example, a floor grid (e.g., the floor grid 552 shown in FIG. 5) may be provided for containing power supply (e.g., batteries, cabling, etc.) and/or other components. In an example of a palletized rack, a modular insert system could be provided within the ISO shipping container, for example where mobile platforms are preloaded onto removable palletized racks that facilitate easier transfer of mobile platform assemblies in and out of the ISO shipping container (e.g., using forklifts, etc.), for example optimizing turnaround and reloading times.

In some examples, an automated loading system is provided, for example featuring conveyor mechanisms and/or robotic arms that place mobile platforms into launch positions within the ISO shipping container. This automation reduces manual handling, for example decreasing the risk of damage and improving loading precision.

Optionally, reinforcements and/or structural support enhancements within the ISO shipping container framework accommodate additional loads and dynamic forces experienced during launch. Such reinforcements and/or structural supports improve stability and operational integrity.

Some examples of the disclosure support real-time reconfiguration of mobile platform payloads, for example through interchangeable modules. This adaptability enables alterations in sensor packages, payload types, and/or the like, for example tailored to mission requirements without necessitating manual retooling, enhancing versatility and operational readiness.

Optionally, in addition or instead of the top of the ISO shipping container opening, some implementations involve modifying the side panels of the ISO shipping container allow for (e.g., sliding, hinged, etc.) openings, which for example would facilitate side launch (e.g., ejection, etc.) of mobile platforms (e.g., advantageous for scenarios requiring lateral deployment, etc.).

In some examples, guide rails for the mobile platforms are integrated into the ISO shipping container, for example in a manner that facilitates efficient and controlled deployment. For example, guide rails may be affixed along the interior walls of the ISO shipping container, for example positioned parallel to each other on opposite sides. This configuration supports vertical stacking of mobile platforms, allowing for efficient use of available space. In some examples, the positioning of the guide rails may correspond to the layout of the tubes designed for rotorcraft, for example enabling a more seamless interaction between storage and launch functions of the ISO shipping container. In some examples, the guide rails are fabricated from relatively lightweight, durable materials such as aluminum and/or composite materials to uphold structural integrity while minimizing additional weight imposed on the ISO shipping container. Optionally, the design of the guide rails could include a U-shaped cross-section, for example to ensure the smooth sliding of mobile platforms along the guide paths without obstruction.

Optionally, adjustable mounting points are provided for the guide rails, for example facilitating more precise alignment and spacing tailored to specific mobile platform sizes and/or configurations. Such an approach allows for reconfiguration based on the dimensions and deployment requirements of various mobile platform payloads. In some examples, a locking and release mechanism is incorporated into the guide rails, for example enabling more secure retention of mobile platform stacks during transport and/or better controlled release during deployment. This mechanism may be electronically and/or pneumatically actuated, potentially integrating with remote and/or automated systems. Optionally, to assist with alignment during loading, the guide rails may be equipped with alignment guide pins and/or tapered sections at entry points. These assistive features would streamline the insertion and retrieval of mobile platform stacks from the guide rail system, for example providing more efficient loading and unloading processes and reducing manual handling maneuvers.

In some examples, a spacer system is provided that includes employing spacer elements of predefined thickness positioned between mobile platforms within the ISO shipping container to maintain an approximately uniform separation, for example during alignment, during transport, to ensure adequate separation for relatively efficient deployment and/or collision avoidance during transport and/or launch, and/or the like. The spacers may be made from relatively lightweight materials and/or be designed to snap onto and/or slide between mobile platforms, for example ensuring relatively consistent spacing while providing stability during transport.

In another example, a suspension system is utilized to facilitate separation between adjacent mobile platforms. For example, each mobile platform may be attached to a suspension mechanism such as, but not limited to, tensioned cables, elastic bands, and/or the like. Such a suspension system allows mobile platforms to remain suspended at predetermined intervals, for example minimizing contact and/or ensuring individual clearances. The suspension system can provide vertical separation, for example enabling mobile platforms to remain distinct during transit, launch, deployment, and/or the like.

A rotary arm system is another exemplary separation implementation. For example, a rotary arm mechanism may include mobile platforms positioned on rotating arms fixed to a central mounting hub. The arms may extend radially, for example maintaining horizontal separation between mobile platforms, and/or allowing for relatively efficient organization. In some examples, upon deployment (e.g., launch, etc.), the arms pivot and/or retract to release the mobile platforms (e.g., sequentially, synchronously, etc.) without interference.

Another implementation includes a telescopic separation system. For example, a telescopic rod configuration may be provided wherein mobile platforms are attached at various segments to provide a scalable means to separate the mobile platforms. For example, each segment corresponds to a mobile platform attachment point. As the rod is extended, mobile platforms are distanced appropriately (e.g., incrementally separated, etc.), for example adequate spacing necessary for ensuring unobstructed launch pathways.

A rack and pinion system is another example. An example of a rack and pinion system involves mounting each mobile platform on an individual platform with rack gears, for example which is movable across the horizontal plane via pinon activation. The platforms can be moved apart by actuating the pinion gears, for example maintaining relatively precise separations, enabling relatively precise control over the separation between mobile platforms, ensuring clear launch paths, and/or facilitating controlled deployment.

In some implementations, the simultaneous launch of vertically stacked mobile platforms may be facilitated (e.g., assisted, etc.) through the integration of synchronized release mechanisms. A synchronized release system including synchronized release mechanisms is capable of achieving a synchronized release, for example providing simultaneous launch capability for vertically stacked mobile platforms, thereby optimizing their deployment and operational efficiency. Such synchronized release mechanisms include, but are not limited to, coordinated release systems, pyrotechnic separation devices, electromagnetic release mechanisms, mechanical interlock systems, pneumatic liberation systems, hydraulic release systems, and/or the like.

In an example of a coordinated release system, supports may be equipped with an actuator that releases the mobile platform upon receiving a synchronized signal, which can be transmitted wirelessly and/or via a wired connection. Examples of pyrotechnic separation devices include small pyrotechnic charges strategically placed within each support. Upon activation, the pyrotechnic charges can break the connections at precisely the same moment, for example allowing all mobile platforms to initiate launch concurrently. Electromagnetic release mechanism examples include, but are not limited to, electromagnets within the supports to secure the mobile platforms in place, wherein activation of the electromagnets via a simultaneous electrical signal will release all mobile platforms at once.

An example of a mechanical interlock system includes releasing a series of mechanical linkages that hold each mobile platform in place using one or more mechanical actions. For example, pulling a central pin and/or lever connected to interlock mechanisms disengages the mobile platforms simultaneously. In an example of a pneumatic liberation system, pressurized air can be used to create a forceful release of the mobile platforms. For example, a system of pneumatic pistons, bladders, and/or the like may simultaneously push each mobile platform out of its support upon activation, for example ensuring concurrent deployment. A hydraulic release system example includes employing hydraulic actuators, with a central hydraulic system providing simultaneous release pressure to all mobile platforms. The mobile platforms, attached via hydraulic couplings, are ejected by synchronized hydraulic force.

### Exemplary Operating Environment

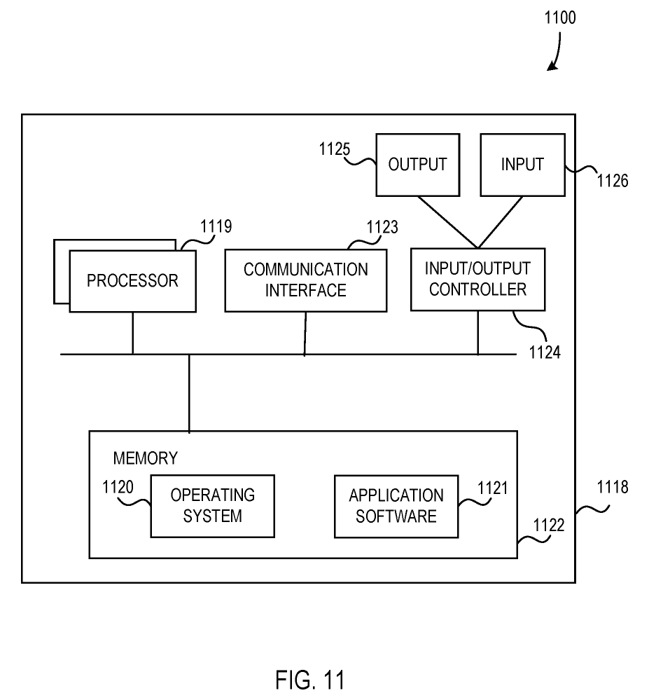

The present disclosure is operable with a computing apparatus according to an implementation as a functional block diagram 1100 in FIG. 11. In an example, components of a computing apparatus 1118 are implemented as a part of circuitry of an electronic device according to one or more implementation described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hard-coded machine. In some examples, platform software comprising an operating system 1120 and/or any other suitable platform software is provided on the apparatus 1118 to enable application software 1121 to be executed on the device.

In some examples, the operations, actions, and/or the like of the systems disclosed herein (e.g., launching mobile platforms, etc.) is accomplished by software, hardware, firmware, and/or the like operating on a single device (e.g., a software module, a processor, a core, a firmware module, and/or the like) or distributed across multiple devices (e.g., one or more software modules, one or more processors, one or more cores, one or more firmware modules, and/or the like). For example, the systems disclosed herein may include a computer storage medium storing instructions that, when executed across two or more processors (and/or across two or more cores of one or more processors), cause the processors (and/or the cores) of the system to collectively perform the operations, actions, and/or the like of the system. For example, one processor of the system could perform one or more of the operations, actions, and/or the like of the system, while another processor could perform one or more other operations, actions, and/or the like of the system.

As used in this application, the term “circuitry” may refer to one or more or all of the following: (a) hardware-only circuit implementations (such as implementations in analog, digital, and/or quantum circuitry); (b) combinations of hardware circuit(s) and software, such as (as applicable): (i) combination of analog, digital, and/or quantum hardware circuit(s) with software/firmware, and (ii) any or all portions of hardware processor(s) (including digital and/or quantum processor(s)) with software, and memory(ies) that work together to cause an apparatus, such as a mobile device, computing device, and/or server, to perform various functions; and (c) any or all portions of hardware circuit(s), such as a microprocessor(s), processor(s), and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit and/or processor (or multiple processors) and/or portion of a hardware circuit and/or processor and its (and/or their) accompanying software and/or firmware. The term circuitry also covers, for example, and if applicable to the particular claim element, a baseband integrated circuit and/or processor integrated circuit for a mobile device and/or a similar integrated circuit in server, a cellular network device, and/or other computing and/or network device.

In some examples, computer executable instructions are provided using any computer-readable media that is accessible by the computing apparatus 1118. Computer-readable media include, for example, computer storage media and communications media. Computer storage media, such as a memory 1122, include volatile and non-volatile, removable, and non-removable media implemented in any method or technology for storage of information such as computer readable instructions, data structures, program modules, and/or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1122) is shown within the computing apparatus 1118, it will be appreciated by a person skilled in the art, that, in some examples, the storage is distributed or located remotely and accessed via a network or other communication link (e.g., using a communication interface 1123).

Further, in some examples, the computing apparatus 1118 comprises an input/output controller 1124 configured to output information to one or more output devices 1125, for example a display (e.g., displaying a GUI) or a speaker, which are separate from or integral to the electronic device. Additionally, or alternatively, the input/output controller 1124 is configured to receive and process an input from one or more input devices 1126, for example, a keyboard, a microphone, or a touchpad. In one example, the output device 1125 also acts as the input device. An example of such a device is a touch sensitive display. The input/output controller 1124 may also output data to devices other than the output device, e.g., a locally connected printing device. In some examples, a user provides input to the input device(s) 1126 and/or receives output from the output device(s) 1125.

The functionality described herein can be performed, at least in part, by one or more hardware logic components. According to an implementation, the computing apparatus 1118 is configured by the program code when executed by the processor 1119 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Examples

Aspects of the disclosure include a launching container assembly that includes an International Organization for Standardization (ISO) shipping container that includes a body that extends a length from a first end to a second end. The body includes an interior compartment configured to hold a stack of mobile platforms therein, a bottom wall extending along the length of the body, side walls extending from the first end to the second end, end walls at the first and second ends, and a top extending along the length of the body. The top includes a closed position and an open position. The body includes an exit opening in the open position of the top. The top is configured to move from the closed position to the open position such that the mobile platforms are configured to be launched from the interior compartment of the ISO shipping container through the exit opening.

In some examples, the mobile platforms are configured to be launched from the interior compartment of the ISO shipping container through the exit opening under power of the mobile platforms.

Optionally, the top includes a panel door that is configured to move from the closed position to the open position by moving down along at least one of: at least one of the side walls; or at least one of the end walls.

In some examples, the top includes a roller door that is configured to move from the closed position to the open position by winding up.

In some examples, the top at least one of: includes a door that includes at least one of jamb type hardware, track type hardware, a track, a rail, a hinge, a roller, a spring, a torsion spring, an extension spring, a counterbalance, or a lift mechanism; includes a door that is configured to be automatically opened; is at least one of sectional or includes a door that is sectional; or includes at least one of a hinged door, a flexible sheet, an explosive panel, or a clamshell arrangement.

Optionally, the launching container assembly further includes at least one of a rail, a rod, a support, a bracket, a tube, or a fin that is configured to guide the mobile platforms during launch of the mobile platforms from the ISO shipping container.

Optionally, the launching container assembly further includes at least one of: at least one of a rail, a rod, a support, a bracket, a tube, or a fin that is configured to hold the mobile platforms in alignment within the stack; an approximately vertical guide configured to guide the mobile platforms during launch of the mobile platforms from the ISO shipping container; or a guide that extends at an approximately oblique angle with respect to the bottom wall of the ISO shipping container, the guide being configured to guide the mobile platforms during launch of the mobile platforms from the ISO shipping container.

In some examples, the ISO shipping container includes at least one of: a power source; an environmental system comprising at least one of a heating mechanism or a cooling mechanism; or at least one of a floor grid, a rack, or a palletized rack.

Optionally, the launching container assembly further includes at least one of: a remote operation system configured to at least one of remotely move the top to the open position or remotely initiate launch of the mobile platforms from the ISO shipping container; or an automatic launch system configured to automatically initiate launch of the mobile platforms from the ISO shipping container.

In some examples, the ISO shipping container includes a twenty-foot equivalent (TEU) container or a forty-foot equivalent (FEU) container.

In some examples, at least one of the end walls is configured to open.

In some examples, the interior compartment of the ISO shipping container is configured to hold at least two stacks of mobile platforms.

In some examples, the mobile platforms include at least one of an uncrewed aerial vehicle (UAV), a rotorcraft, or a fixed wing aircraft.

Aspects of the disclosure include a launching container assembly that includes a stack of mobile platforms, and an ISO shipping container that includes a body that extends a length from a first end to a second end. The body includes an interior compartment holding the stack of mobile platforms therein, a bottom wall extending along the length of the body, side walls extending from the first end to the second end, end walls at the first and second ends, and a top extending along the length of the body and including a closed position and an open position. The body includes an exit opening in the open position of the top. The top is configured to move from the closed position to the open position such that the mobile platforms are configured to be launched from the interior compartment of the ISO shipping container through the exit opening.

Aspects of the disclosure include a method that includes moving a top of an ISO shipping container from a closed position of the top to an open position of the top such that the ISO shipping container includes an exit opening, wherein the ISO shipping container contains a stack of mobile platforms in an interior compartment of the ISO shipping container. The method includes launching the mobile platforms from the interior compartment of the ISO shipping container through the exit opening of the ISO shipping container.

Optionally, moving the top of the ISO shipping container from the closed position to the open position includes at least one of automatically or remotely moving the top from the closed position to the open position.

Optionally, launching the mobile platforms from the interior compartment of the ISO shipping container includes at least one of: flying the mobile platforms through the exit opening of the ISO shipping container; launching the mobile platforms from the interior compartment under power of the mobile platforms; or propelling the mobile platforms through the exit opening of the ISO shipping container.

Optionally, launching the mobile platforms from the interior compartment of the ISO shipping container includes at least one of: at least one of automatically or remotely launching the mobile platforms from the interior compartment; or launching the mobile platforms from the interior compartment in a checkerboard pattern.

In some examples, launching the mobile platforms from the interior compartment of the ISO shipping container includes launching the mobile platforms in an order based on functions of the mobile platforms.

Optionally, the method further includes installing the stack of mobile platforms within the interior compartment of the ISO shipping container.

Aspects of the disclosure include a launching container assembly that includes an ISO shipping container. The ISO shipping container includes an interior compartment configured to receive a stack of mobile platforms therein, and a top configured to open to enable the mobile platforms to exit the interior compartment of the ISO shipping container.

Optionally, the top includes a panel door that is configured to open by moving down along at least one of a side wall or an end wall of the ISO shipping container.

In some examples, the top includes a roller door that is configured to open by winding up.

In some examples, the top includes a door including at least one of jamb type hardware, track type hardware, a track, a rail, a hinge, a roller, a spring, a torsion spring, an extension spring, a counterbalance, or a lift mechanism.

In some examples, the top includes a door that is configured to be automatically opened.

Optionally, the top is at least one of sectional or includes a door that is sectional.

Optionally, the top includes at least one of a hinged door, a flexible sheet, an explosive panel, or a clamshell arrangement.

Optionally, the launching container assembly further includes at least one of a rail, a rod, a support, a bracket, a tube, or a fin that is configured to guide the mobile platforms during launch of the mobile platforms from the ISO shipping container.

Optionally, the launching container assembly further includes at least one of a rail, a rod, a support, a bracket, a tube, or a fin that is configured to hold the mobile platforms in alignment within the stack.

In some examples, the launching container assembly further includes an approximately vertical guide configured to guide the mobile platforms during launch of the mobile platforms from the ISO shipping container.

In some examples, the launching container assembly further includes a guide that extends at an approximately oblique angle with respect to a bottom of the ISO shipping container. The guide is configured to guide the mobile platforms during launch of the mobile platforms from the ISO shipping container.

Optionally, the ISO shipping container includes a power source.

In some examples, the launching container assembly further includes a remote operation system configured to at least one of remotely open the top or remotely initiate launch of the mobile platforms from the ISO shipping container.

Optionally, the launching container further includes an automatic launch system configured to automatically initiate launch of the mobile platforms from the ISO shipping container.

In some examples, the ISO shipping container includes an environmental system including at least one of a heating mechanism or a cooling mechanism.

In some examples, the ISO shipping container includes at least one of a floor grid, a rack, or a palletized rack.

Optionally, the ISO shipping container includes a twenty-foot equivalent (TEU) container or a forty-foot equivalent (FEU) container.

In some examples, the ISO shipping container extends a length from a first end to a second end. The ISO shipping container includes a bottom, end walls at the first and second ends, and side walls extending lengths from the first end to the second end. The side walls extend heights between the bottom and the top, wherein at least one of the end walls is configured to open.

In some examples, the interior compartment of the ISO shipping container is configured to hold at least two stacks of mobile platforms.

Optionally, the mobile platform includes at least one of a UAV, a rotorcraft, or a fixed wing aircraft.

Aspects of the disclosure include a launching container assembly that includes a stack of mobile platforms, and a shipping container including a body having an interior compartment and a top. The interior compartment is configured to receive the stack of the mobile platforms therein. The top of the body is configured to open to enable the mobile platforms to exit the interior compartment of the body.

Aspects of the disclosure include a method that includes opening a top of an International Organization for Standardization (ISO) shipping container, wherein the ISO shipping container contains a stack of mobile platforms therein, and launching the mobile platforms from the ISO shipping container through the open top.

In some examples, opening the top of the ISO shipping container includes at least one of automatically or remotely opening the top.

In some examples, launching the mobile platforms from the ISO shipping container includes flying the mobile platforms through the open top of the ISO shipping container.

Optionally, launching the mobile platforms from the ISO shipping container includes propelling the mobile platforms through the open top of the ISO shipping container.

Optionally, launching the mobile platforms from the ISO shipping container includes at least one of automatically or remotely launching the mobile platforms from the ISO shipping container.

In some examples, launching the mobile platforms from the ISO shipping container includes launching the mobile platforms from the ISO shipping container in a checkerboard pattern.

Optionally, launching the mobile platforms from the ISO shipping container includes launching the mobile platforms in an order based on functions of the mobile platforms.

In some examples, the method further includes installing the stack of mobile platforms within an interior compartment of the ISO shipping container.

Aspects of the disclosure includes a containerized launch system for mobile platforms that includes a shipping container modified to serve as a launch platform for mobile platforms, wherein the container includes an internal framework housing a plurality of mobile platforms. The containerized launch system includes a launch mechanism within the container, including launch rails configured for the deployment of quadcopters and fixed-wing mobile platforms. The launch mechanism further includes vertical tubes for quadcopters and horizontal pneumatic launchers for fixed-wing mobile platforms. The containerized launch system includes a roof mechanism configured to transition between a closed position and an open position. The roof mechanism is designed in a manner selected from the group consisting of roll-up, hinged segment, and clamshell configurations, to facilitate the deployment of mobile platforms. The containerized launch system includes a power management system within the container, including at least one power source selected from the group consisting of batteries, generators, and solar panels. The containerized launch system includes a remote operation system configured to permit automated initiation of mobile platform launch sequences from a remote computer system. The containerized launch system includes an environmental adaptation system, including at least one heating mechanism within the container to prevent ice and snow accumulation on the launch components. The containerized launch system includes a modular and scalable mobile platform storage system, including palletized racks for mobile platform loading and unloading.

Aspects of the disclosure include a method for deploying mobile platforms using a containerized launch system, including the steps of: positioning a shipping container at a designated launch location, wherein the container is configured with internal structures for storing and launching a plurality of mobile platforms; initiating a power management system within the container, the system including at least one power source selected from the group consisting of batteries, generators, and solar panels; actuating a roof mechanism configured to transition from a closed state to an open state, the mechanism chosen from configurations including roll-up, hinged segment, or clamshell designs, thereby exposing the container's interior for mobile platform deployment; engaging a remote operation system to trigger an automated launch sequence, enabling the sequential or simultaneous release of mobile platforms, while minimizing on-site personnel involvement; deploying quadcopters and fixed-wing mobile platforms using a multi-functional launch mechanism, wherein quadcopters are released through vertical tubes and fixed-wing mobile platforms are ejected via horizontal pneumatic launchers; monitoring environmental conditions within the container and activating an environmental adaptation system comprising heating mechanisms; and utilizing a modular storage system for organizing mobile platforms on palletized racks.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as "first," "second," "third," etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A launching container assembly comprising:
an International Organization for Standardization (ISO) shipping container comprising a body that extends a length from a first end to a second end, wherein the body comprises:
an interior compartment configured to hold a stack of mobile platforms therein;
a bottom wall extending along the length of the body;
side walls extending from the first end to the second end;
end walls at the first and second ends; and
a top extending along the length of the body and comprising a closed position and an open position, the body comprising an exit opening in the open position of the top, wherein the top is configured to move from the closed position to the open position such that the mobile platforms are configured to be launched from the interior compartment of the ISO shipping container through the exit opening.

2. The launching container assembly of claim 1, wherein the mobile platforms are configured to be launched from the interior compartment of the ISO shipping container through the exit opening under power of the mobile platforms.

3. The launching container assembly of claim 1, wherein the top comprises a panel door that is configured to move from the closed position to the open position by moving down along at least one of:
at least one of the side walls; or
at least one of the end walls.

4. The launching container assembly of claim 1, wherein the top comprises a roller door that is configured to move from the closed position to the open position by winding up.

5. The launching container assembly of claim 1, wherein the top at least one of:
comprises a door that comprises at least one of jamb type hardware, track type hardware, a track, a rail, a hinge, a roller, a spring, a torsion spring, an extension spring, a counterbalance, or a lift mechanism;
comprises a door that is configured to be automatically opened;
is at least one of sectional or comprises a door that is sectional; or
comprises at least one of a hinged door, a flexible sheet, an explosive panel, or a clamshell arrangement.

6. The launching container assembly of claim 1, further comprising at least one of a rail, a rod, a support, a bracket, a tube, or a fin that is configured to guide the mobile platforms during launch of the mobile platforms from the ISO shipping container.

7. The launching container assembly of claim 1, further comprising at least one of:
at least one of a rail, a rod, a support, a bracket, a tube, or a fin that is configured to hold the mobile platforms in alignment within the stack;
an approximately vertical guide configured to guide the mobile platforms during launch of the mobile platforms from the ISO shipping container; or
a guide that extends at an approximately oblique angle with respect to the bottom wall of the ISO shipping container, the guide being configured to guide the mobile platforms during launch of the mobile platforms from the ISO shipping container.

8. The launching container assembly of claim 1, wherein the ISO shipping container comprises at least one of:
a power source;
an environmental system comprising at least one of a heating mechanism or a cooling mechanism; or
at least one of a floor grid, a rack, or a palletized rack.

9. The launching container assembly of claim 1, further comprising at least one of:
a remote operation system configured to at least one of remotely move the top to the open position or remotely initiate launch of the mobile platforms from the ISO shipping container; or
an automatic launch system configured to automatically initiate launch of the mobile platforms from the ISO shipping container.

10. The launching container assembly of claim 1, wherein the ISO shipping container comprises a twenty-foot equivalent (TEU) container or a forty-foot equivalent (FEU) container.

11. The launching container assembly of claim 1, wherein at least one of the end walls is configured to open.

12. The launching container assembly of claim 1, wherein the interior compartment of the ISO shipping container is configured to hold at least two stacks of mobile platforms.

13. The launching container assembly of claim 1, wherein the mobile platforms comprise at least one of an uncrewed aerial vehicle (UAV), a rotorcraft, or a fixed wing aircraft.

14. A launching container assembly comprising:
a stack of mobile platforms; and
an International Organization for Standardization (ISO) shipping container comprising a body that extends a length from a first end to a second end, wherein the body comprises:
an interior compartment holding the stack of mobile platforms therein;
a bottom wall extending along the length of the body;
side walls extending from the first end to the second end;
end walls at the first and second ends; and
a top extending along the length of the body and comprising a closed position and an open position, the body comprising an exit opening in the open position of the top, wherein the top is configured to move from the closed position to the open position such that the mobile platforms are configured to be launched from the interior compartment of the ISO shipping container through the exit opening.

15. A method comprising:
moving a top of an International Organization for Standardization (ISO) shipping container from a closed position of the top to an open position of the top such that the ISO shipping container includes an exit opening, wherein the ISO shipping container contains a stack of mobile platforms in an interior compartment of the ISO shipping container; and
launching the mobile platforms from the interior compartment of the ISO shipping container through the exit opening of the ISO shipping container.

16. The method of claim 15, wherein moving the top of the ISO shipping container from the closed position to the open position comprises at least one of automatically or remotely moving the top from the closed position to the open position.

17. The method of claim 15, wherein launching the mobile platforms from the interior compartment of the ISO shipping container comprises at least one of:
flying the mobile platforms through the exit opening of the ISO shipping container;
launching the mobile platforms from the interior compartment under power of the mobile platforms; or
propelling the mobile platforms through the exit opening of the ISO shipping container.

18. The method of claim 15, wherein launching the mobile platforms from the interior compartment of the ISO shipping container comprises at least one of:
at least one of automatically or remotely launching the mobile platforms from the interior compartment; or
launching the mobile platforms from the interior compartment in a checkerboard pattern.

19. The method of claim 15, wherein launching the mobile platforms from the interior compartment of the ISO shipping container comprises launching the mobile platforms in an order based on functions of the mobile platforms.

20. The method of claim 15, further comprising installing the stack of mobile platforms within the interior compartment of the ISO shipping container.
